(19) United States
(12) Patent Application Publication
(10) Pub. No.: US 2026/0142897 A1
(43) Pub. Date: May 21, 2026

(54) DISTRIBUTING REQUESTS FOR PROCESSING IN CLOUD COMPUTING SYSTEMS BASED ON SERVICE LEVEL AGREEMENTS

(71) Applicant: SAP SE, Walldorf (DE)

(72) Inventor: Hui Li, Shanghai (CN)

(21) Appl. No.: 18/955,174

(22) Filed: Nov. 21, 2024

(51) Int. Cl. H04L 41/5025; G06F 9/50

(52) U.S. Cl. CPC H04L 41/5025; G06F 9/5038

(57) ABSTRACT

Methods, systems, and computer-readable storage media for receiving a third request to be processed wherein the third request is received after a first request and a second request, determining a first quality of service (QoS) value associated with the third request, determining an insert position for the third request at least partially based on the first quality of service (Qos) value where the insert position is between the first and second positions of the at least one request queue, inserting the third request into the at least one request queue at the insert position, and distributing the first, second and third requests queued in the at least one request queue for processing by one or more processors within a cloud computing environment.

### BACKGROUND

Enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) offering). Cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). In some instances, clients (e.g., client-side computing devices) transmit requests to a cloud computing environment, which requests are routed to a server for processing.

### SUMMARY

Implementations of the present disclosure are directed to distributing requests for processing in cloud computing systems. More particularly, implementations of the present disclosure are directed to inserting requests in request queues based on service level agreements (SLAs) of respective tenants in cloud computing systems.

In some implementations, actions are executed for processing requests in cloud computing systems where at least one request queue contains a first request at a first position of the at least one request queue and a second request at a second position of the at least one request queue where the first request was received and inserted into the at least one request queue before the second request, the actions can include receiving a third request to be processed wherein the third request is received after the first request and the second request, determining a first quality of service (QoS) value associated with the third request, determining an insert position for the third request at least partially based on the first quality of service (Qos) value where the insert position is between the first and second positions of the at least one request queue, inserting the third request into the at least one request queue at the insert position, and distributing the first, second and third requests queued in the at least one request queue for processing by one or more processors within a cloud computing environment. Other implementations of this aspect include corresponding systems, apparatus, and computer programs, configured to perform the actions of the methods, encoded on computer storage devices.

These and other implementations can each optionally include one or more of the following features: actions further include calculating a maximum offset position for the third request at least partially based on the first QoS value, wherein the insert position is determined to be equal to the maximum offset position in response to determining that QoS values of requests between the first position and the second position are less than the first QoS value of the third request; the insert position is determined to be immediately after the first position in response to determining that a second QoS value of the first request is greater than or equal to the first QoS value of the third request; the insert position is determined to be immediately after the first position in response to determining that a time delay of the first request is greater than or equal to a maximum time delay; the maximum offset position is further calculated based on a length of the queue when the third request is received and a maximum QoS value; actions further include determining a relative first time for the first request that indicates a time as to how long the first request has been in the at least one request queue, the relative first time being used to determine the insert position of the third request; the determining the insert position further includes determining if the first relative time equals or exceed a maximum time amount such that the insert position is then determined to be just after the first position; and the insert position is determined to be immediately after the second position in response to the maximum position offset being equal to zero.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIGS. 2A and 2B depict respective example request handling architectures in accordance with implementations of the present disclosure.

FIGS. 3A-3D depict examples of request queues in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to distributing requests for processing in cloud computing systems. More particularly, implementations of the present disclosure are directed to inserting requests in request queues based on service level agreements (SLAs) of respective tenants in cloud computing systems.

In some implementations, actions are executed for processing requests in cloud computing systems where at least one request queue contains a first request at a first position of the at least one request queue and a second request at a second position of the at least one request queue where the first request was received and inserted into the at least one request queue before the second request, the actions can include receiving a third request to be processed wherein the third request is received after the first request and the second request, determining a first quality of service (QoS) value associated with the third request, determining an insert position for the third request at least partially based on the first quality of service (Qos) value where the insert position is between the first and second positions of the at least one request queue, inserting the third request into the at least one request queue at the insert position, and distributing the first, second and third requests queued in the at least one request queue for processing by one or more processors within a cloud computing environment.

To provide further context for implementations of the present disclosure, and as introduced above, enterprises can use enterprise applications to support and execute operations. Enterprise applications can be deployed in cloud computing environments, which includes execution of the enterprise applications within a data center of a cloud-computing provider (e.g., as part of a infrastructure-as-a-service (IaaS) and/or a software-as-a-service (SaaS) offering). Cloud computing can be described as Internet-based computing that provides shared computer processing resources, and data to computers and other devices on demand.

Enterprise applications can be deployed for access by multiple tenants. In some examples, each tenant can include an enterprise that is able to access the enterprise application in the cloud computing environment. For example, clients of tenants can establish respective sessions, during which processing resources, and bandwidth are consumed. A client can include, for example and without limitation, a user (e.g., using a tenant-side computing device) of an application (e.g., executing on a tenant-side computing device). During a session, for example, a client is provided on-demand access to the enterprise application, which is executed using a shared pool of configurable computing resources (e.g., computer networks, servers, storage, applications, and services).

Multiple instances of the enterprise application can be executed on respective application servers within the cloud computing environment. For example, multiple tenants can access an enterprise resource planning (ERP) system, wherein instances of the ERP system are executed on multiple application servers. That is, multiple application servers execute respective instances of the same application (e.g., ERP system). As such, clients (e.g., tenant-side computing devices) transmit requests to the cloud computing environment, which requests are routed to one of the application servers for processing. In traditional cloud computing environments, a load balancer (e.g., executing at a gateway of the cloud computing environment) dispatches requests to application servers using a dispatch policy. Example dispatch policies include, without limitation, round-robin scheduling and modified round-robin scheduling. Such scheduling policies, however, are at the request level. Consequently, when a request hits the gateway of the cloud computing environment, the gateway will redirect the request to an application server based on the dispatch policy without regard to the particular tenant that the request originated from. In such scenarios, it is possible for all or a majority of the application servers to be receiving client requests from a single tenant where such a distribution outcome is not efficient for the cloud computing environment.

Moreover, different tenants have different grades of SLAs with providers of cloud computing environments. In general, a SLA guarantees a specified quality of service (QoS) for a respective tenant. In some examples, QoS can be defined in terms of rate of throughput (e.g., rate at which requests can be submitted), availability (e.g., of backend resources for handling requests), and latency (e.g., time required to handle requests and returns responses). Tenants having SLAs defining higher QoS should obtain better service than tenants having SLAs with lower QoS. For example, the cloud computing system should guarantee that requests from tenants having higher QoS should be performaed before requests from tenants having lower QoS.

In traditional approaches, one method that attempts to guarantee the QoS for tenants is to limit request rates of the different tenants at the gateway side. When distributing requests for handling, traditional approaches use a queue, such as a first-in-first-out (FIFO) queue. In such an approach, a process (or thread) adds tenant requests to a tail of the FIFO queue, and multiple executors (processes or threads) pick up the requests from a head of the FIFO queue and execute the requests one by one. In such a FIFO queue, the requests closer to the head of the quesue are before the requests closer to to the tail (e.g., the request at the head of FIFO queue would be executed before the request at the tail of the FIFO queue). Such a FIFO queue works well when sufficient hardware/software resources are available for processing requests. However, when availability of hardware/software resources diminishes, such as during period of heavy request loads, problems can arise in meeting QoS of different tenants. For example, requests of tenants having lower QoS can block requests of tenants having higher QoS requests. As a result, requests of tenants having higher QoS can see lagging response times, for example, which can break SLAs.

In view of the above context, implementations of the present disclosure provide an improved approach to distributing requests in cloud computing environments. More particularly, and as described in further detail herein, implementations of the present disclosure are directed to inserting requests in request queues based on service level agreements (SLAs) of respective tenants in cloud computing systems. In some implementations, a maximum offset position for a request is determined at least partially based on a QoS value (also referred to herein as grade) of the request, and an insert position for the request is determined at least partially based on the position offset. The request is inserted into the request queue at the insert position.

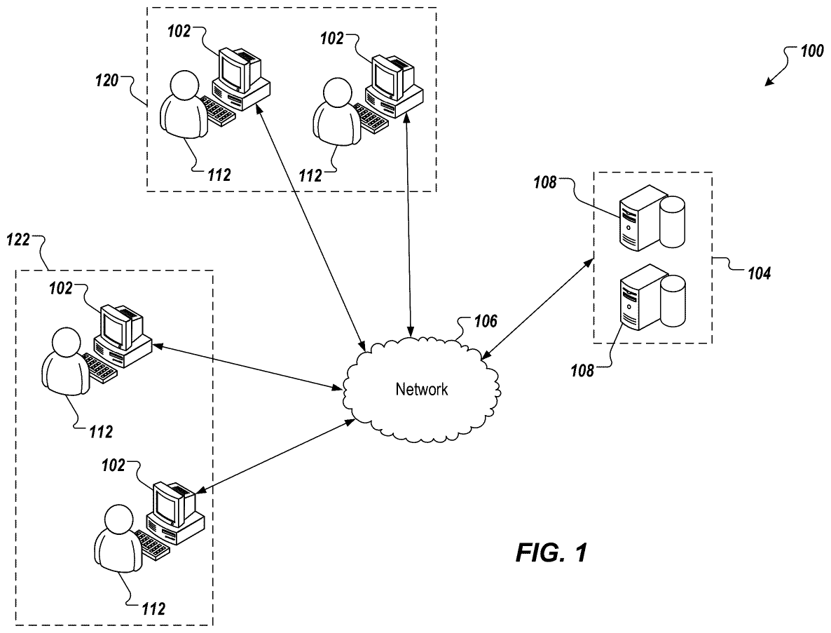

FIG. 1 depicts an example architecture 100 in accordance with implementations of the present disclosure. In the depicted example, the example architecture 100 includes client devices 102, a network 106, and a server system 104. The server system 104 includes one or more server devices and databases 108 (e.g., processors, memory). In the depicted example, users 112 interact with the client devices 102. In the example of FIG. 1, a set of users 112 and respective client devices 102 can be associated with a first tenant 120 and a set of users 112 and respective client devices 102 can be associated with a second tenant 122.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes one or more servers 108. In the example of FIG. 1, the server system 104 is intended to represent various forms of servers including, but not limited to a web server, an application server, a proxy server, a network server, and/or a server pool. In general, server systems accept requests for services and provides such services to any number of client devices (e.g., the client device 102 over the network 106).

In some implementations, the server system 104 can embody a cloud computing environment, in which one or more of the servers 108 are application servers that receive requests, process the requests, and provide responses. For example, a server 108 can receive a request from the client device 102. In accordance with implementations of the present disclosure, and as described in further detail herein, requests can be inserted into request queues based on SLAs of respective tenants, such as the first tenant 120 and the second tenant 122, in cloud computing systems. In this manner, instances of breaking SLAs through diminished QoS can be mitigated.

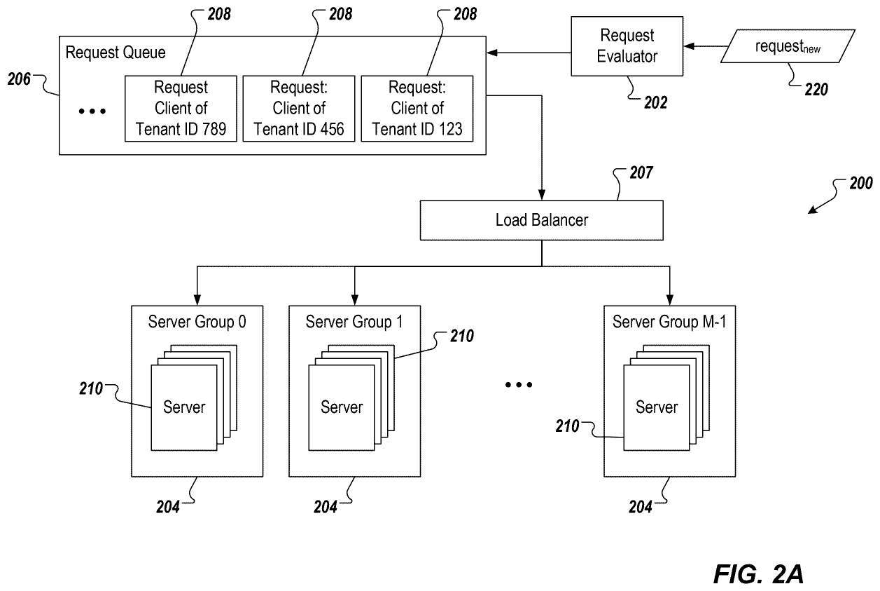

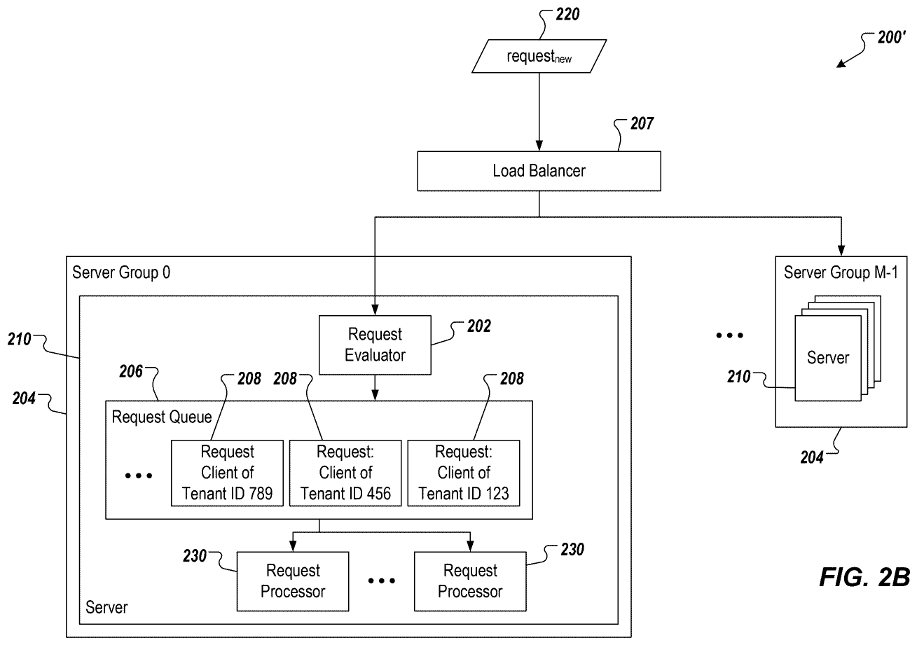

FIG. 2A depicts an example request handling architecture 200 in accordance with implementations of the present disclosure. In some examples, the request handling architecture 200 of FIG. 2A is provided by the server system 104 of FIG. 1. In the example of FIG. 2A, the request handling architecture 200 is depicted and includes a request evaluator 202, server groups 204, a request queue 206, and a load balancer 207. The request queue 206 includes requests 208 issued from two or more tenants, which are to be routed to application servers 210 of respective server groups 204. Each request 208 includes an identifier that uniquely identifies a tenant.

The example of FIG. 2A represents one example system for distribution of the requests to server groups 204. An example of this is disclosed in commonly assigned U.S. application Ser. No. 18/332,860, filed Jun. 12, 2023, the disclosure of which is expressly incorporated herein by reference for all purposes. It is contemplated, however, that implementations of the present disclosure can be realized in any appropriate system for distributing requests to servers for handling.

In accordance with implementations of the present disclosure, the request evaluator 202 evaluates requests, such as a request 220, that are received for processing. As described in further detail herein, the request evaluator 202 attempts to insert the request 220 at a position within the request queue 206 before the tail position such that the newly added request would be pulled from the queue before the existing tale request. This differs from other systems that default to adding the request at the end of the request queue so it becomes the new tail of the request queue 206 such that the newly added request would be pulled from the request queue 206 after the current tail request. The advanced insert position, from a technical implementation perspective, accounts for QoS of the tenant that submitted the request 220 with respect to the requests 208 that are pending in the request queue 206 when the request 220 is received.

In further detail and in accordance with implementations of the present disclosure, integers are assigned to represent respective grades of the QoSs. For example, a set of grades {1, 2, 3, . . . , N} is provided and each QoS is assigned a grade. The higher the grade, the higher the QoS is. Further, implementations of the present disclosure selectively insert requests at different points in a queue (e.g., the request queue 206 of FIG. 2A) to provide varying levels of tenant throughput, response time and resource access based on QoS. For example, implementations of the present disclosure provide the following example relationship:

$${L}_{offset} = ⌊ \frac{qos - 1}{MAX\_QOS - 1} \times γ \times {L}_{queue} ⌋ \qquad ( 1 )$$

where L_{offset} represents a maximum offset position after a tail of the request queue that a request can be inserted at, qos is the grade assigned to QoS of the tenant that submitted the request, MAX_QoS is the highest grade that can be assigned to a QoS (e.g., N), L_{queue} is the current length of the queue (e.g., in terms of number of requests queued), γ is a constant (e.g., 0≤γ≤1) with γ=0 meaning requests are always added to the tail of the queue, and └x┘ indicate rounding down x to an integer. The value L_{offset}, when calculated in one implementation, is used as a limit by which the newly received request cannot be inserted into the request queue 206 before the current tail request.

In some implementations, especially when there is a plurality of existing requests in request queue 206 between the tail request position and the request L_{offset} position before the tail request, a request with a lower QoS cannot be inserted before a request with a higher or equal QoS within that span of the request queue. In yet further implementations, a constant MAX_DELAY_TIME is provided for at least some of the requests already in request queue 206. If a time delay of a request already in request queue 206 is greater than or equal to MAX_DELAY_TIME, a new request cannot be added before such a request in a span of the request queue. In some examples, the time delay is calculated as a time difference between a current timestamp and a timestamp of when the request is inserted into the queue.

When a request (request_{new}) is received by the cloud computing environment, a thread (e.g., the request evaluator 202 of FIG. 2A) will attempt to insert the new request before the tail position as limited by L_{offset}. More particularly, in response to receiving the request, L_{offset} is calculated using Equation 1, above. For example, the thread (e.g., the request evaluator 202 of FIG. 2A) stores data representative of a current state of the request queue (e.g., L_{queue}) when a new request is received and data representative of tenants and respective QoSs (e.g., a table that maps tenants to respective QoSs and or grades (qos)).

In some implementations, a current position (P_{current}) is initially set as the tail of the queue (i.e., after the last request in the queue) and an integer i is set equal to 0. As will be described later, the current position (P_{current}) is used to retrieve data from individual requests already in request 206 and i is used as a counter to determine if the maximum position in which the new request can be placed has been reached as determined by L_{offset}. It is determined whether i≥L_{offset}. If i≥L_{offset}, the request (request_{new}) is inserted after P_{current} and timestamp indicating when the request was inserted is recorded (e.g., the new request becomes the new tail of request queue 206). If i<L_{offset}, the request at P_{current} is designated as a check request (request check) allowing for data associated with or part of request check can be read. If there is not a request at P_{current}, the request (request_{new}) is inserted after P_{current} and timestamp indicating when the request was inserted is recorded. If request check exists, a grade of the QoS of the request check (QoS_{check}) is compared to a grade of the request_{new} (QoS_{new}). If QoS_{check}≥QoS_{new}, request_{new} is inserted after P_{current} and timestamp indicating when the request was inserted is recorded. If QoS_{check}<QoS_{new}, it is determined whether a time delay of request_{check} (T_{check}) is greater than or equal to the MAX_DELAY_TIME (T_{MAX}). If T_{check}≥T_{MAX}, request_{new} is inserted after P_{current} and timestamp indicating when the request was inserted is recorded. If T_{check}<T_{MAX}, P_{current} is moved one position forward in the queue, the integer i is incremented, and another attempt is made to determine whether to insert request_{new} before P_{current}.

It can be noted that, in the case of sufficient hardware/software resources, once a request is inserted into the queue, it will be picked up by one executor and executed relatively quickly. If the length of the queue is relatively short (or is 0) and the value L_{offset} of the following requests is nearly 0, the request queue functions as FIFO notwithstanding insertion.

FIG. 2B depicts another example request handling architecture 200′ in accordance with implementations of the present disclosure. In the example of FIG. 2B, the request evaluator 202 and the request queue are provisioned within a server 210 of a server group 210. In some examples, requests 208 are distributed from the request queue 206 to request processors 230 within the server 210. More particularly, the request 220 is received at the load balancer 207, which dispatches requests to application servers using a dispatch policy. For example, the request 220 is dispatched to the request evaluator 202, which evaluates the request 220 and inserts the request 220 within the request queue 206, as described in detail herein.

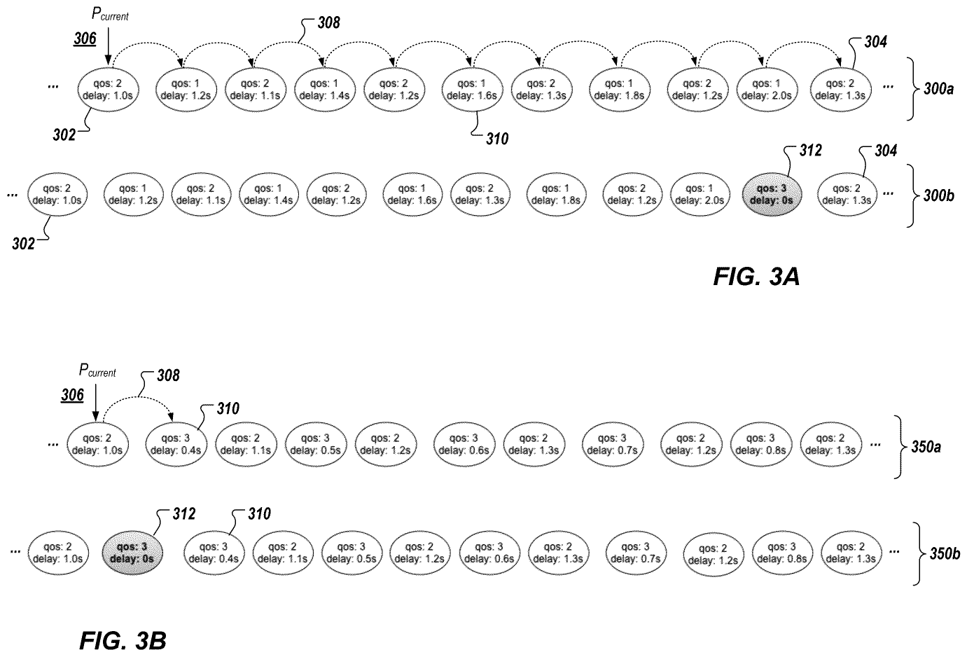

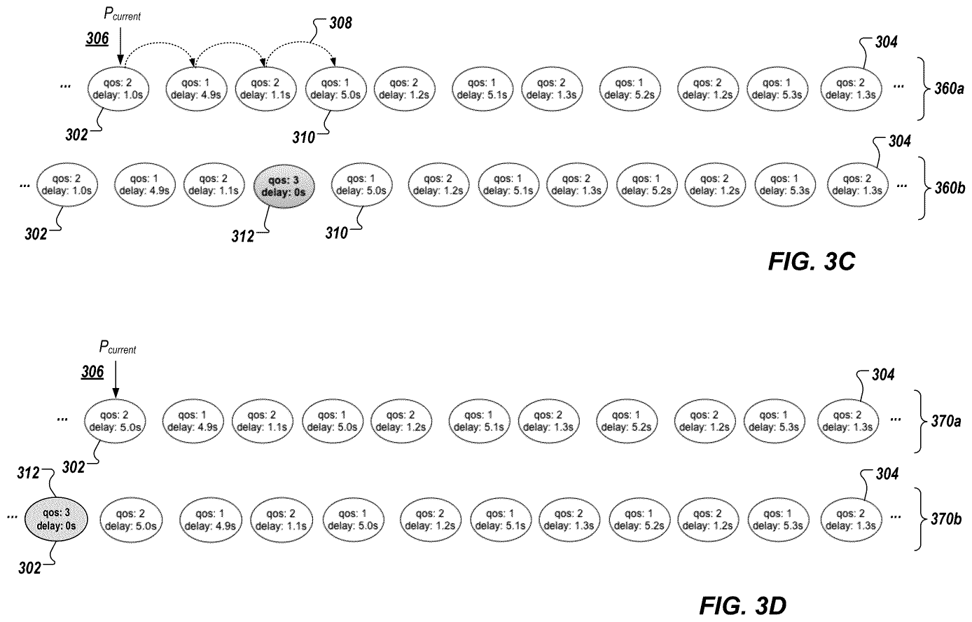

To illustrate implementations of the present disclosure, reference is made to non-limiting examples of inserting requests into queues. More particularly, FIGS. 3A-3D depict examples of request queues and insertion of requests in accordance with implementations of the present disclosure. The examples of FIGS. 3A-3D are based on an example, in which MAX_QoS is 5, y is 0.2, MAX_DELAY_TIME is 5 seconds, and a current length of the queue L_{queue} is 100. In this example, a request (request_{new}) of a tenant is received, and the tenant has a qos of 3. In this example, the maximum offset of the position before the tail that a request can be inserted to is determined as:

$${L}_{offset} = ⌊ \frac{3 - 1}{5 - 1} \times 0.2 \times 100 ⌋ = 10$$

FIG. 3A depicts an example of a first request queue 300a before the above-example request is inserted into the request queue 300a. Request queue 300a at this point in time has a more recently added request (e.g., substantially added after many if not all of the other requests shown in first request queue 300a) designated as the tail 302 (e.g., there are no other requests after, or visually shown to the left of tail 302, in request queue 300a). Request 304 is L_{offset}, or 10, positions away from tail 302. An index, reference structure or pointer P_{current} 306 is initially set as to read from or reference data associated with the request at the tail 302. As the process progresses, P_{current} 306 is moved through the request queue 300a as shown by dotted lines 308 until the counter i is equal to or greater than L_{offset} (e.g., 10 in this example) and P_{current} is referring to request 304. At each movement 308 of P_{current} 306, values of qos from each intermediate request such as 310 are compared to the qos of the new received requests. In addition, the time amount that each intermediate request 310 has been in request queue 304 is compared against T_{MAX}. The result of this process is shown in modified request queue 300b where the newly added request 312 is added to request queue 300b after the last request 304 in the span designated by L_{offset}. That is, the new request 312 is inserted ten (10) offsets or positions before the tail 302 of the request queue 300b. New request 312 was inserted at such an advanced position in request queue 300b because a) its qos of 3 is higher than all qos values of all intermediate requests 310 and b) none of the intermediate requests 310 had a time value greater than T_{MAX}=5. It should be noted also in request queue 300b that L_{offset} prevented new request 312 from being inserted at any position beyond the tenth position from tail 302.

FIG. 3B depicts an example of a second request queue 350a before the above-example request is inserted. The reference numbers 302, 304, 306, 308 and 310 represent like elements shown in FIG. 3A. Similar to FIG. 3A, P_{current} 306 is initially set at tail 302 and then advanced to intermediate 310 as shown by dotted line 308. The qos of the newly received request is compared to the qos value of intermediate request 310. It is determined that the qos values are equal (e.g., 3). This combination of process operations sets the insertion point as just after intermediate request 310 as shown in modified request queue 350b in FIG. 3B.

FIG. 3C depicts an example of a third request queue 360a before the above-example request is inserted. The reference numbers 302, 304, 306, 308 and 310 represent like elements shown in FIGS. 3A and 3B. Similar to FIGS. 3A and 3B, P_{current} 306 is initially set to reference tail request 302. P_{current} 306 is advanced through request queue 360a comparing qos values and time values to T_{MAX}. When P_{current} 306 references intermediate request 310, the time value of intermediate request 310 is compared against T_{MAX}. It is determined that the time value of request 310 is equal to T_{MAX} (e.g., 5). This combination of operations sets the insertion point for the newly received request 312 as just after intermediate node 310 shown in modified third request queue 360b.

FIG. 3D depicts an example of a fourth request queue 370a before the above-example request is inserted. The reference numbers 302, 304, 306, and 310 represent like elements shown in FIGS. 3A, 3B and 3C. Similar to FIGS. 3A, 3B, and 3C, P_{current} 306 is initially set to reference tail request 302. In this example, the qos value of the newly received request is compared to the qos value of the tail request 302. It is determined that they are equal (e.g., values of 3). In addition, or alternatively, the time value of tail request 302 is compared to T_{MAX} where it is determined that the time value associated with tail request 302 is equal to, or greater than T_{MAX} (T_{MAX}=5). Either condition, or alternatively both conditions together, set the insertion point for newly received request 312 as the new tail 302. There are other conditions in which the newly received request 312 would be set as the new tail 302. As previously described, if an administrator sets γ=0, or if there are fewer requests from tenants such that the tail and head of request 370a are the same, which prevents P_{current} from advancing past tail 302 for further processing, then the newly received request 312 would become the new tail 302 as shown in request queue 370b.

The various request queues shown in FIGS. 3A-3D may be implemented in any type of data structure. One such structure would be a linked list where inserting a newly received request in the middle of request queue would be accomplished with minimum disruption to the existing requests in the request queue. However, this is just any example. In addition, it should be noted that the operational parameters of the various requests which would eventually be executed to provide a tenant with a result or response are omitted for clarity (e.g., operations, data values, references to data tables or other data structures, etc). Finally, the time values shown in FIGS. 3A-3D are the relative time differences calculated between the timestamp in which the request was inserted into the request queue and the current time and are used in these figures for clarity and ease of understanding. However, storing the timestamp, or storing a time value that is incremented, or some other way to measure time a request in the request queue may be used.

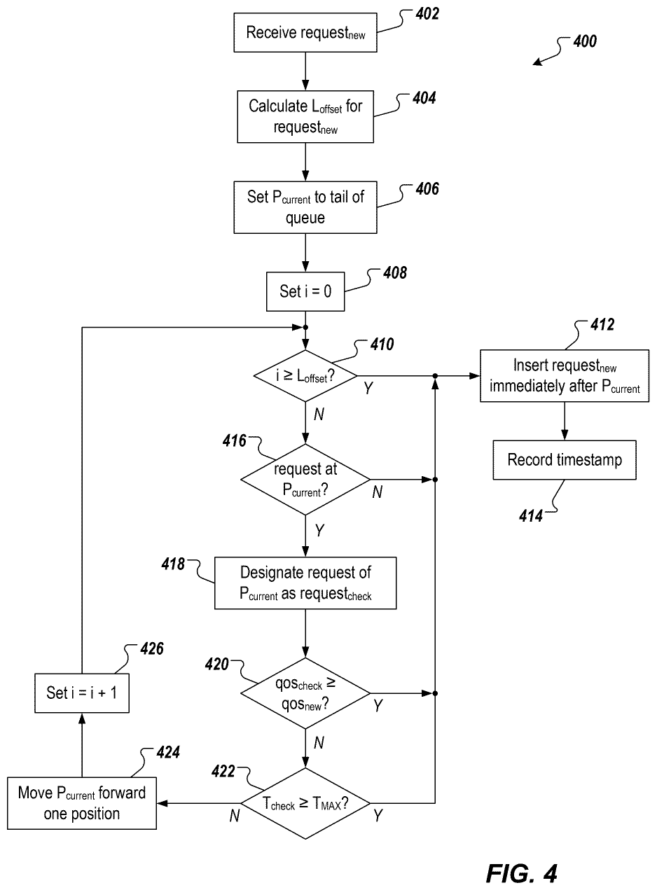

FIG. 4 depicts an example process 400 that can be executed in accordance with implementations of the present disclosure. In some examples, the example process 400 is provided using one or more computer-executable programs executed by one or more computing devices.

A request (request_{new}) is received (402). For example, and as described herein, the request 220 can be received by the request evaluator 202. In some examples, the request is associated with an identifier that uniquely identifies the tenant that submitted the request. L_{offset} is calculated for request_{new} (404). For example, and as described herein, the request evaluator 202 calculates L_{offset} for request_{new} using Equation 1, above. In some examples, the request evaluator 202 determines qos for the tenant, using a tenant ID retrieved from request_{new} (e.g., from a table of tenant IDs and associated qos values) and determines L_{queue} (e.g., from data representative of a current state of the request queue 206). P_{current} is set to the tail of the request queue (406) and integer i is set equal to 0 (408).

It is determined whether i≥L_{offset} (410). If i≥L_{offset}, request_{new} is inserted after P_{current} (412) and a timestamp indicating when the request was inserted is recorded (414). For example, if i is 0 and L_{offset} is 0 (e.g., L_{queue}=0), request_{new} is inserted just after the tail. The timestamp that is recorded is used to determined the time delay for request_{new} when subsequent requests are being considered for insertion, as described in detail herein. If i<L_{offset}, it is determined whether there is a request at P_{current} (416). If there is not request at P_{current}, request_{new} is inserted after P_{current} (412) and the timestamp indicating when the request was inserted is recorded (414).

If there is a request at P_{current}, the request at P_{current} is designated as a check request (request check) (418). A grade of the QoS of the request check (qOS_{check}) is compared to a grade of the request_{new} (qOS_{new}) (420). For example, the request evaluator 202 can determine qos check value from data representative of the request_{check} in request queue 206 and compare it to the qos_{new} value of request_{new}. If qos_{check}≥qOS_{new}, request_{new} is inserted after P_{current} (412) and the timestamp indicating when the request was inserted is recorded (414). If qos_{check}<qOS_{new}, it is determined whether a time delay of request check (T_{check}) is greater than or equal to the MAX_DELAY_TIME (T_{MAX}) (422). If T_{check}≥T_{MAX}, request_{new} is inserted after P_{current} (412) and the timestamp indicating when the request was inserted is recorded (414). If T_{check}<T_{MAX}, P_{current} is moved one position forward in the queue (424), the integer i is incremented (426), and the example process 400 loops back in another attempt is made to determine whether to insert request_{new} before P_{current}.

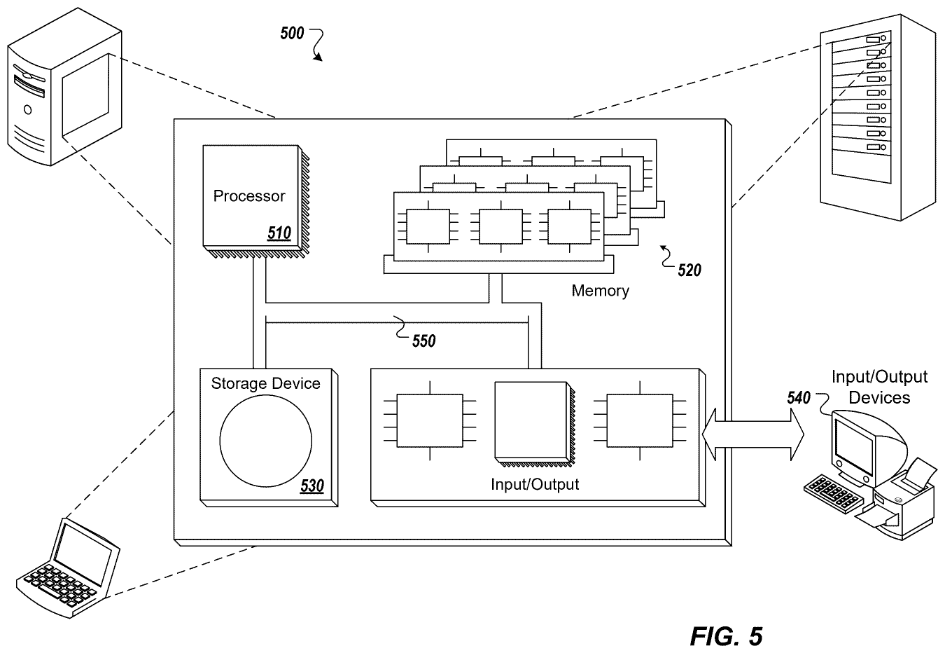

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations thereof. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for inserting requests into request queues for processing requests in cloud computing systems where at least one request queue contains a first request at a first position of the at least one request queue and a second request at a second position of the at least one request queue where the first request was received and inserted into the at least one request queue before the second request, the method being executed by one or more processors and comprising:
receiving a third request to be processed wherein the third request is received after the first request and the second request;
determining a first quality of service (QoS) value associated with the third request;
determining an insert position for the third request at least partially based on the first QoS value where the insert position is between the first and second positions of the at least one request queue;
inserting the third request into the at least one request queue at the insert position; and
distributing the first, second and third requests queued in the at least one request queue for processing by one or more processors within a cloud computing environment.

2. The computer-implemented method of claim 1, further comprising:
calculating a maximum offset position for the third request at least partially based on the first QoS value, wherein the insert position is determined to be equal to the maximum offset position in response to determining that QoS values of requests between the first position and the second position are less than the first QoS value of the third request.

3. The computer-implemented method of claim 2, wherein the maximum offset position is further calculated based on a length of the queue when the third request is received and a maximum QoS value.

4. The computer-implemented method of claim 1, wherein the insert position is determined to be immediately after the first position in response to determining that a second QoS value of the first request is greater than or equal to the first QoS value of the third request.

5. The computer-implemented method of claim 1, wherein the insert position is determined to be immediately after the first position in response to determining that a time delay of the first request is greater than or equal to a maximum time delay.

6. The computer-implemented method of claim 1, further comprising:
determining a relative first time for the first request that indicates a time as to how long the first request has been in the at least one request queue;
the relative first time being used to determine the insert position of the third request.

7. The computer-implemented method of claim 6, wherein the determining the insert position further comprises determining if the first relative time equals or exceed a maximum time amount such that the insert position is then determined to be just after the first position.

8. The computer-implemented method of claim 1, wherein the insert position is determined to be immediately after the second position in response to the maximum position offset being equal to zero.

9. A non-transitory computer-readable storage medium coupled to one or more processors and having instructions stored thereon which, when executed by the one or more processors, cause the one or more processors to perform operations for inserting requests into request queues for processing requests in cloud computing systems where at least one request queue contains a first request at a first position of the at least one request queue and a second request at a second position of the at least one request queue where the first request was received and inserted into the at least one request queue before the second request, the operations comprising:
receiving a third request to be processed wherein the third request is received after the first request and the second request;
determining a first quality of service (QoS) value associated with the third request;
determining an insert position for the third request at least partially based on the first QoS value where the insert position is between the first and second positions of the at least one request queue;
inserting the third request into the at least one request queue at the insert position; and
distributing the first, second and third requests queued in the at least one request queue for processing by one or more processors within a cloud computing environment.

10. The non-transitory computer-readable storage medium of claim 9, wherein operations further comprise:
calculating a maximum offset position for the third request at least partially based on the first QoS value, wherein the insert position is determined to be equal to the maximum offset position in response to determining that QoS values of requests between the first position and the second position are less than the first QoS value of the third request.

11. The computer-implemented method of claim 10, wherein the maximum offset position is further calculated based on a length of the queue when the third request is received and a maximum QoS value.

12. The non-transitory computer-readable storage medium of claim 9, wherein the insert position is determined to be immediately after the first position in response to determining that a second QoS value of the first request is greater than or equal to the first QoS value of the third request.

13. The non-transitory computer-readable storage medium of claim 9, wherein the insert position is determined to be immediately after the first position in response to determining that a time delay of the first request is greater than or equal to a maximum time delay.

14. The non-transitory computer-readable storage medium of claim 9, wherein operations further comprise:
determining a relative first time for the first request that indicates a time as to how long the first request has been in the at least one request queue;
the relative first time being used to determine the insert position of the third request.

15. A system, comprising:
a computing device; and
a computer-readable storage device coupled to the computing device and having instructions stored thereon which, when executed by the computing device, cause the computing device to perform operations for processing requests in cloud computing systems where at least one request queue contains a first request at a first position of the at least one request queue and a second request at a second position of the at least one request queue where the first request was received and inserted into the at least one request queue before the second request, the operations comprising:
receiving a third request to be processed wherein the third request is received after the first request and the second request;
determining a first quality of service (QoS) value associated with the third request;
determining an insert position for the third request at least partially based on the first QoS value where the insert position is between the first and second positions of the at least one request queue;
inserting the third request into the at least one request queue at the insert position; and
distributing the first, second and third requests queued in the at least one request queue for processing by one or more processors within a cloud computing environment.

16. The system of claim 15, wherein operations further comprise:
calculating a maximum offset position for the third request at least partially based on the first QoS value, wherein the insert position is determined to be equal to the maximum offset position in response to determining that QoS values of requests between the first position and the second position are less than the first QoS value of the third request.

17. The system of claim 16, wherein the maximum offset position is further calculated based on a length of the queue when the third request is received and a maximum QoS value.

18. The system of claim 15, wherein the insert position is determined to be immediately after the first position in response to determining that a second QoS value of the first request is greater than or equal to the first QoS value of the third request.

19. The system of claim 15, wherein the insert position is determined to be immediately after the first position in response to determining that a time delay of the first request is greater than or equal to a maximum time delay.

20. The system of claim 15, wherein operations further comprise:
determining a relative first time for the first request that indicates a time as to how long the first request has been in the at least one request queue;
the relative first time being used to determine the insert position of the third request.
